(19) United States
(12) Patent Application Publication
(10) Pub. No.: US 2023/0226626 A1
(43) Pub. Date: Jul. 20, 2023

(54) INDEXABLE MILLING CUTTER COOLING SYSTEM AND METHOD

(71) Applicant: KENNAMETAL INDIA LIMITED, Bangalore (IN)

(72) Inventors: Bharath Arumugam, Bangalore (IN); Padmakumar Muthuswamy, Bangalore (IN)

(21) Appl. No.: 17/992,277

(22) Filed: Nov. 22, 2022

(30) Foreign Application Priority Data
Jan. 18, 2022 (IN) 202241002768

(51) Int. Cl. B23C 5/28; B23C 5/20

(52) U.S. Cl. CPC B23C 5/282; B23C 5/20

(57) ABSTRACT

A milling tool includes a rotatable tool body, a cutting insert, and first and second coolant outlets. The rotatable tool body is configured to rotate around an axis. The rotatable tool body includes a circumferential outer surface with a pocket defined therein. The pocket includes a seating surface. The cutting insert is disposed within the pocket. The cutting insert includes a seating face and a rake face opposed to the seating face. The seating face is disposed against the seating surface. The first coolant outlet is disposed in or attached to the rotatable tool body disposed on an opposite side of the rake face as the seating face. The second coolant outlet is disposed in or attached to the rotatable tool body disposed on an opposite side of the seating face as the rake face. The second coolant outlet is disposed outside of and adjacent to the seating face.

### RELATED APPLICATION DATA

The present application claims priority pursuant to 35 U.S.C. § 119(a) to Indian Patent Application Number 202241002768 filed Jan. 18, 2022 which is incorporated herein by reference in its entirety.

### FIELD OF THE DISCLOSURE

The disclosure relates to milling tools and to methods of their cooling.

### BACKGROUND

Existing milling tools often utilize one coolant outlet to direct coolant onto a corner of a cutting insert. This is frequently not sufficient to cool full lengths of the cutting edges of the cutting insert. This may lead to reduced tool life.

A milling tool and method of its cooling is needed to efficiently cool the full length of the cutting edges of a cutting insert to prolong tool life.

### SUMMARY

In one embodiment, a milling tool is disclosed. The milling tool includes a rotatable tool body, a cutting insert, at least one first coolant outlet, and at least one second coolant outlet. The rotatable tool body is configured to rotate around an axis. The rotatable tool body includes a circumferential outer surface and a pocket defined within the circumferential outer surface. The pocket includes a seating surface. The cutting insert is disposed within the pocket. The cutting insert includes a seating face and a rake face opposed to the seating face. The seating face is disposed against the seating surface. The at least one first coolant outlet is disposed in or attached to the rotatable tool body disposed on an opposite side of the rake face as the seating face.

The at least one second coolant outlet is disposed in or attached to the rotatable tool body disposed on an opposite side of the seating face as the rake face. The at least one second coolant outlet is disposed outside of and adjacent to the seating face.

In another embodiment, a milling tool is disclosed. The milling tool includes a rotatable tool body, a cutting insert, at least one first coolant outlet, at least one second coolant outlet, and at least one third coolant outlet. The rotatable tool body is configured to rotate around an axis. The rotatable tool body includes a circumferential outer surface and a pocket defined within the circumferential outer surface. The pocket includes a seating surface and first and second side surfaces disposed transversely to the seating surfaces. The cutting insert is disposed within the pocket. The cutting insert includes a seating face, a rake face opposed to the seating face, and first and second flank faces extending between the seating face and the rake face. The seating face is disposed against the seating surface. The first flank face is disposed against the first side surface. The second flank face is disposed against the second side surface. The at least one first coolant outlet is disposed in or attached to the rotatable tool body. The at least one first coolant outlet is disposed on an opposite side of the rake face as the seating face adjacent the first flank face. The at least one second coolant outlet is disposed in or attached to the rotatable tool body. The at least one second coolant outlet is disposed on an opposite side of the seating face as the rake face. The at least one third coolant outlet is disposed in or attached to the rotatable tool body. The at least one third coolant outlet is disposed on an opposite side of the rake face as the seating face adjacent the second flank face.

In still another embodiment, a method of cooling a milling tool is disclosed. In one step, a tool body of a milling tool is rotated around an axis. A seating face of a cutting insert is disposed against a seating surface of a pocket defined within a circumferential outer surface of the tool body. A rake face of the cutting insert is opposed to the seating face. In another step, the cutting insert disposed within the pocket is cooled by flowing coolant out of at least one first coolant outlet onto the cutting insert, and by flowing the coolant out of at least one second coolant outlet onto the cutting insert. The at least one first coolant outlet is disposed on an opposite side of the rake face as the seating face. The at least one first coolant outlet is disposed in or attached to the tool body. The at least one second coolant outlet is disposed on an opposite side of the seating face as the rake face outside of and adjacent to the seating face. The at least one second coolant outlet is disposed in or attached to the tool body.

The scope of the present disclosure is defined solely by the appended claims and is not affected by the statements within this summary.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 illustrates a top perspective view of one embodiment of a milling tool;

FIG. 2 illustrates a bottom perspective view of the embodiment of FIG. 1;

FIG. 3 illustrates a close-up perspective view of a pocket of the milling tool of the embodiment of FIG. 1 showing a cutting insert disposed within the pocket;

FIG. 4 illustrates a cross-sectional view along line 4-4 of the embodiment of FIG. 2;

FIG. 5 illustrates a partial perspective view around a pocket of the milling tool of the embodiment of FIG. 1, with the cutting insert removed, using dashed lines to show coolant channels; and

FIG. 6 is a flowchart illustrating one embodiment of a method of cooling a milling tool.

### DETAILED DESCRIPTION

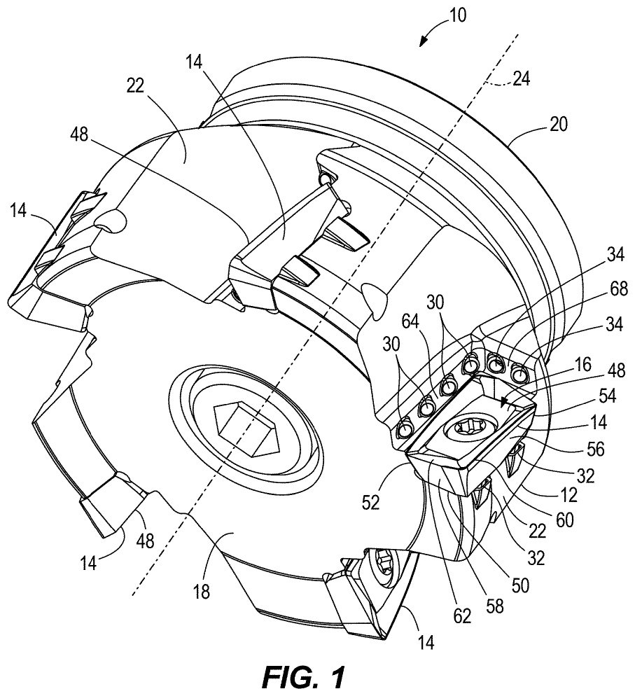

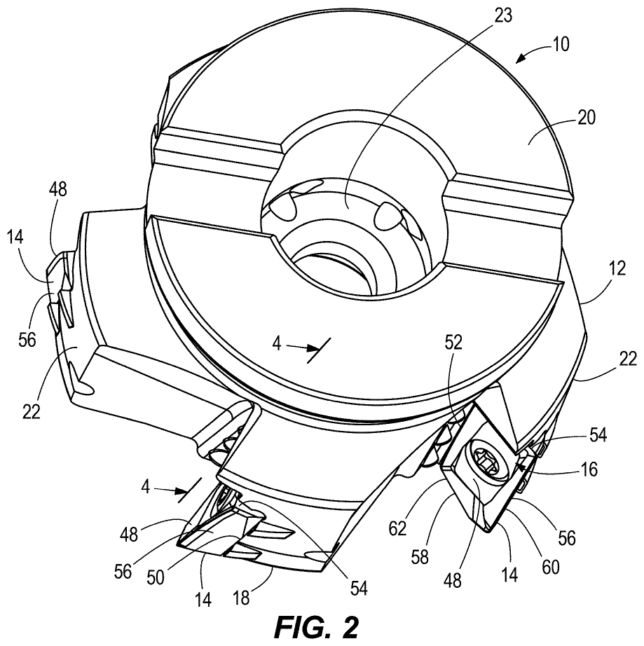

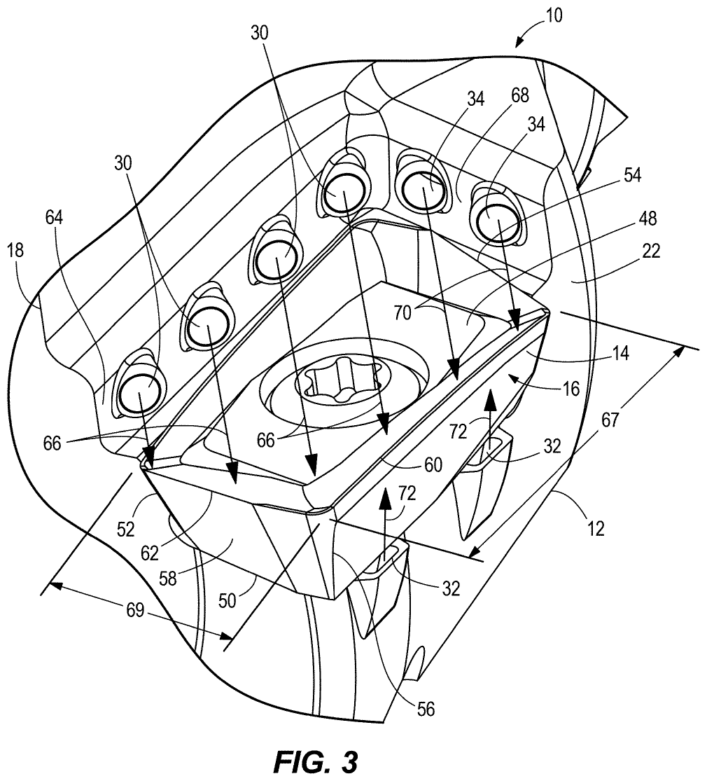

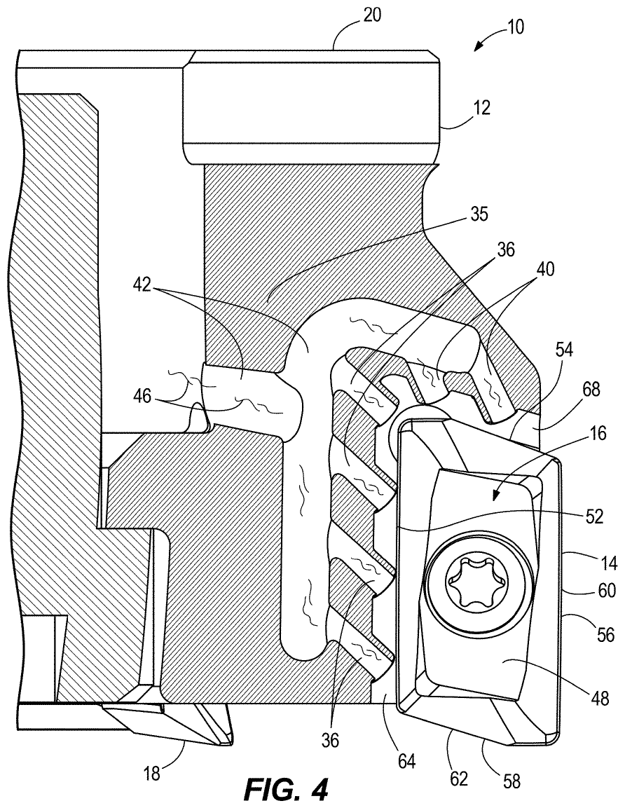

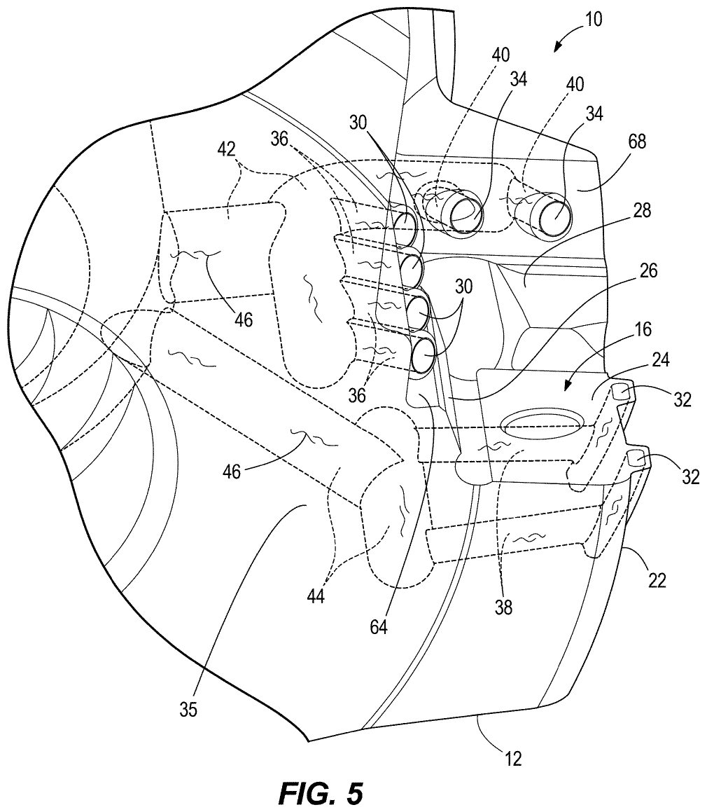

As illustrated in FIGS. 1-5 collectively, a milling tool 10 is disclosed. The milling tool 10 comprises a rotatable tool body 12 and cutting inserts 14 detachably disposed within pockets 16 of the rotatable tool body 12. The milling tool 10 may be used to conduct indexable shoulder milling of a part. In other embodiments, the milling tool 10 may be used to conduct varying types of milling operations.

The rotatable tool body 12 comprises opposed top and bottom surfaces 18 and 20, and a circumferential outer surface 22 extending between the opposed top and bottom surfaces 18 and 20. A hole 23 is disposed through the bottom surface 20. A shaft (not shown) attached to a motor (not shown) may be disposed through the hole 23 and fixedly secured within and to the hole 23 so that the rotatable tool body 12 rotates with the shaft around axis 24.

The pockets 16 are defined within the circumferential outer surface 22 and are spaced around the circumferential outer surface 22. The pockets 16 are open at the top surface 18 of the rotatable tool body 12. Each pocket 16 comprises a seating surface 24 and first and second side surfaces 26 and 28 disposed transversely to the seating surface 24. The seating surface 24 is disposed transversely to the circumferential outer surface 22. A plurality of first, second, and third coolant outlets 30, 32, and 34 are disposed in or attached to the rotatable tool body 12. The first coolant outlets 30 are connected to first coolant channels 36 disposed within an interior 35 of the rotatable tool body 12. The second coolant outlets 32 are connected to second coolant channels 38 within an interior 35 of the rotatable tool body 12. The third coolant outlets 34 are connected to third coolant channels 40 within an interior 35 of the rotatable tool body 12. The first and third coolant channels 36 and 40 merge at a first junction coolant channel 42 disposed within the interior 35 of the rotatable tool body 12. The second coolant channels 38 merge at a second junction coolant channel 44 disposed within the interior 35 of the rotatable tool body 12. The first and second junction coolant channels 42 and 44 are each connected within the interior 35 of the rotatable tool body 12 to a coolant supply line (not shown) which supplies coolant 46 to the first, second, and third coolant outlets 30, 32, and 34 through the respective first, second, and third coolant channels 36, 38, and 40.

Each cutting insert 14 comprise a rake face 48, a seating face 50, first, second, third, and fourth flank faces 52, 54, 56, and 58 extending between the rake face 48 and seating face 50, and first and second cutting edges 60 and 62. The rake face 48 and seating face 50 are opposed to one another. The first and third flank faces 52 and 56 are opposed to one another. Similarly, the second and fourth flank faces 54 and 58 are opposed to one another. The first cutting edge 60 comprises the intersection of the rake face 48 and the third flank face 56. The second cutting edge 62 comprises the intersection of the rake face 48 and the fourth flank face 58.

The seating face 50 of each cutting insert 14 is disposed against the respective seating surface 24 of the pocket 16 which it is disposed in. The first flank face 52 of each cutting insert 14 is disposed against the respective first side surface 26 of the pocket 16 which it is disposed in. The second flank face 54 of each cutting insert 14 is disposed against the respective second side surface 28 of the pocket 16 which it is disposed in. The third flank face 56 of each cutting insert 14 freely sits in the open adjacent the circumferential outer surface 22 of the rotatable tool body 12. The fourth flank face 58 of each cutting insert 14 freely sits in the open adjacent the top surface 18 of the rotatable tool body 12. The rake face 48 of each cutting inset 14 sits freely in the open in the respective pocket 16 which it is disposed in.

The first coolant outlets 30 disposed in each respective pocket 16 are disposed on an opposite side of the rake face 48 as the seating face 50 of the cutting insert 14 disposed within a first raised surface 64 of the pocket 16. The first raised surface 64 and the first coolant outlets 30 are disposed over and adjacent to the first side surface 26. The first coolant outlets 30 of each respective pocket 16 are spaced apart from the rake face 48 of the cutting insert 14 adjacent the first flank face 52. The first coolant outlets 30 are configured to discharge the coolant 46 along first paths 66 onto a portion of the length 67 of the first cutting edge 60 and along the entire length 69 of the second cutting edge 62.

The third coolant outlets 34 disposed in each respective pocket 16 are disposed on an opposite side of the rake face 48 as the seating face 50 of the cutting insert 14 disposed within a second raised surface 68 of the pocket 16. The second raised surface 68 and the third coolant outlets 34 are disposed over and adjacent to the second side surface 28. The third coolant outlets 34 of each respective pocket 16 are spaced apart from the rake face 48 of the cutting insert 14 adjacent the second flank face 54. The third coolant outlets 34 are configured to discharge the coolant 46 along third paths 70 onto a portion of length 67 of the first cutting edge 60. The third coolant outlets 34 are disposed on the second raised surface 68 which is disposed transversely to the first raised surface 64 upon which the first coolant outlets 30 are disposed. The third coolant outlets 34 are disposed transversely to the first coolant outlets 30.

The second coolant outlets 32 are disposed in and attached to the circumferential outer surface 22 adjacent to each respective pocket 16. The second coolant outlets 32 of each respective pocket 16 are disposed on an opposite side of the seating face 50 as the rake face 48 of the cutting insert 14 disposed in the pocket 16. The second coolant outlets 32 are disposed outside of and adjacent to the seating face 50 of each respective pocket 16. The second coolant outlets 32 of each respective pocket 16 are spaced apart from the seating face 50 of the cutting insert 14 adjacent the pocket 16. The second coolant outlets 32 are configured to discharge the coolant 46 along second paths 72 onto the entire length 67 of the first cutting edge 60. The second coolant outlets 32 are disposed on the circumferential outer surface 22 which is disposed transversely to the second raised surface 68 upon which the third coolant outlets 34 are disposed. The second coolant outlets 32 are disposed transversely to the third coolant outlets 34.

The first, second, and third coolant outlets 30, 32, and 34 collectively provide the coolant 46 to 100% of the entire lengths 67 and 69 of the first and second cutting edges 60 and 62 by collectively discharging the coolant 46 along the first, second, and third paths 66, 72, and 70, which comprise different paths. In such manner, the first and second cutting edges 60 and 62 are efficiently cooled thereby prolonging the life of the cutting inserts 14 and the milling tool 10.

In other embodiments, the configuration of the milling tool 10 may be altered. For instance, one or more of the components of the milling tool 10 may be removed, one or more of the components of the milling tool 10 may be modified in type, structure, layout, orientation, position, or number, or one or more additional components may be added. For instance, any number of the first, second, and third coolant outlets 30, 32, and 34 may be utilized in varying configurations.

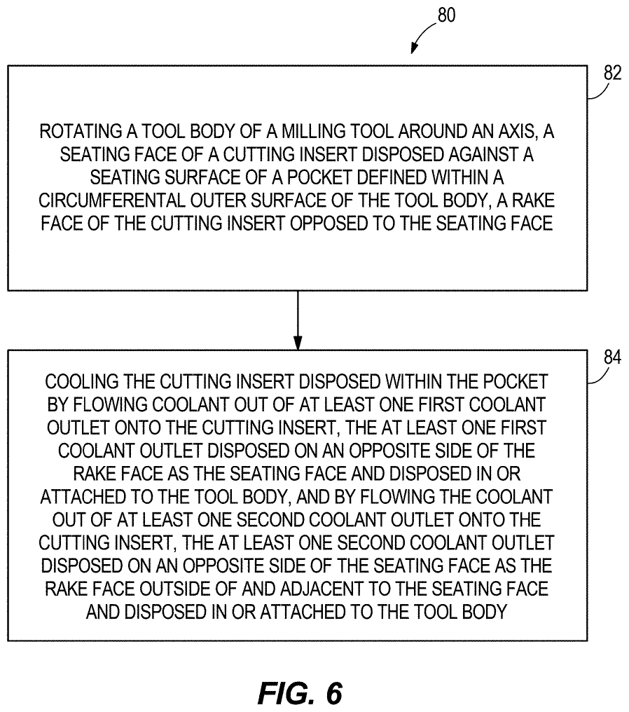

FIG. 6 illustrates one embodiment of a method 80 of cooling a milling tool. The method 80 may utilize any of the milling tool embodiments disclosed herein. In other embodiments, the method may utilize varying milling tools.

In step 82, a tool body of a milling tool, having a cutting insert disposed in a pocket of the tool body, is rotated around an axis. A seating face of the cutting insert is disposed against a seating surface of the pocket defined within a circumferential outer surface of the tool body. A rake face of the cutting insert is opposed to the seating face. In step 84, the cutting insert disposed within the pocket is cooled by flowing coolant out of at least one first coolant outlet onto the cutting insert, and by flowing the coolant out of at least one second coolant outlet onto the cutting insert. The at least one first coolant outlet is disposed on an opposite side of the rake face as the seating face. The at least one first coolant outlet is disposed in or attached to the tool body. The at least one second coolant outlet is disposed on an opposite side of the seating face as the rake face outside of and adjacent to the seating face. The at least one second coolant outlet is disposed in or attached to the tool body.

An optional step which may be added to the method 80 comprises cooling the cutting insert disposed within the pocket by flowing the coolant out of at least one third coolant outlet onto the cutting insert. The at least one third coolant outlet is disposed in or attached to the tool body. The at least one third coolant outlet is disposed on the opposite side of the rake face as the seating face.

Another optional step which may be added to the method 80 comprises: cooling a first cutting edge of the cutting insert by discharging the coolant out of the second and third coolant outlets, and cooling a second cutting edge of the cutting insert by discharging the coolant out of the at least one first coolant outlet.

An additional step which may be added to the method 80 comprises cooling 100% of lengths of the first and second cutting edges by discharging the coolant out of the first, second, and third coolant outlets.

Still another step which may be added to the method 80 comprises: providing the coolant to the at least one first coolant outlet through a first coolant channel disposed within an interior of the tool body; providing the coolant to the at least one second coolant outlet through a second coolant channel disposed within the interior of the tool body; and providing the coolant to the at least one third coolant outlet though a third coolant channel disposed within the interior of the tool body.

The method 80 may utilize varied milling tools having any number of pockets and respective cutting inserts disposed in the pockets. In other embodiments, one or more steps of the method 80 may not be followed, may be modified in substance or order, or one or more additional steps may be added.

One or more embodiments of the invention may reduce one or more issues associated with one or more of the existing milling tools and methods of cooling them. The use of multiple coolant outlets discharging coolant onto the cutting edges of each cutting insert in different paths, in order to supply 360° coolant over the entire lengths of the cutting edges of the cutting inserts, provides efficient cooling prolonging the life of the cutting inserts and the milling tool.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true scope of the subject matter described herein. Furthermore, it is to be understood that the disclosure is defined by the appended claims. Accordingly, the disclosure is not to be restricted except in light of the appended claims and their equivalents.

1. A milling tool comprising:
a rotatable tool body configured to rotate around an axis, the rotatable tool body comprising a circumferential outer surface and a pocket defined within the circumferential outer surface, the pocket comprising a seating surface;
a cutting insert disposed within the pocket, the cutting insert comprising a seating face and a rake face opposed to the seating face, the seating face disposed against the seating surface;
at least one first coolant outlet disposed in or attached to the rotatable tool body disposed on an opposite side of the rake face as the seating face; and
at least one second coolant outlet disposed in or attached to the rotatable tool body disposed on an opposite side of the seating face as the rake face, the at least one second coolant outlet disposed outside of and adjacent to the seating face.

2. The milling tool of claim 1 wherein the pocket further comprises first and second side surfaces disposed transversely to the seating surface, the cutting insert further comprising first and second flank faces extending between the seating face and the rake face, the first flank face disposed against the first side surface, and the second flank face disposed against the second side surface.

3. The milling tool of claim 2 wherein the at least one first coolant outlet is adjacent the first flank face.

4. The milling tool of claim 3 further comprising at least one third coolant outlet disposed in or attached to the rotatable tool body, the at least one third coolant outlet disposed on the opposite side of the rake face as the seating face adjacent the second flank face.

5. The milling tool of claim 1 wherein the at least one second coolant outlet is disposed in or attached to the circumferential outer surface.

6. The milling tool of claim 5 wherein the at least one second coolant outlet is disposed outside of and adjacent to the seating face.

7. The milling tool of claim 1 further comprising at least one third coolant outlet disposed in or attached to the rotatable tool body, the at least one third coolant outlet disposed on the opposite side of the rake face as the seating face, the cutting insert comprising first and second cutting edges, the at least one first coolant outlet positioned to discharge coolant onto the second cutting edge, the at least one second coolant outlet positioned to discharge the coolant onto the first cutting edge, and the at least one third coolant outlet positioned to discharge the coolant onto the first cutting edge.

8. The milling tool of claim 7 wherein the first, second, and third coolant outlets collectively provide the coolant to 100% of lengths of the first and second cutting edges.

9. The milling tool of claim 7 further comprising first, second, and third coolant channels, wherein the first coolant channel is connected to the at least one first coolant outlet, the second coolant channel is connected to the at least one second coolant outlet, and the third coolant channel is connected to the at least one third coolant outlet, the first, second, and third coolant channels disposed within an interior of the rotatable tool body.

10. A milling tool comprising:
a rotatable tool body configured to rotate around an axis, the rotatable tool body comprising a circumferential outer surface and a pocket defined within the circumferential outer surface, the pocket comprising a seating surface and first and second side surfaces disposed transversely to the seating surface;
a cutting insert disposed within the pocket, the cutting insert comprising a seating face, a rake face opposed to the seating face, and first and second flank faces extending between the seating face and the rake face, the seating face disposed against the seating surface, the first flank face disposed against the first side surface, and the second flank face disposed against the second side surface;
at least one first coolant outlet disposed in or attached to the rotatable tool body, the at least one first coolant outlet disposed on an opposite side of the rake face as the seating face adjacent the first flank face;
at least one second coolant outlet disposed in or attached to the rotatable tool body, the at least one second coolant outlet disposed on an opposite side of the seating face as the rake face; and
at least one third coolant outlet disposed in or attached to the rotatable tool body, the at least one third coolant outlet disposed on an opposite side of the rake face as the seating face adjacent the second flank face.

11. The milling tool of claim 10 wherein the at least one second coolant outlet is disposed outside of and adjacent to the seating face.

12. The milling tool of claim 10 wherein the at least one second coolant outlet is disposed in or attached to the circumferential outer surface.

13. The milling tool of claim 10 wherein the cutting insert comprises first and second cutting edges, the at least one first coolant outlet positioned to discharge coolant onto the second cutting edge, the at least one second coolant outlet positioned to discharge the coolant onto the first cutting edge, and the at least one third coolant outlet positioned to discharge the coolant onto the first cutting edge.

14. The milling tool of claim 13 wherein the first, second, and third coolant outlets collectively provide the coolant to 100% of lengths of the first and second cutting edges.

15. The milling tool of claim 10 further comprising first, second, and third coolant channels, wherein the first coolant channel is connected to the at least one first coolant outlet, the second coolant channel is connected to the at least one second coolant outlet, and the third coolant channel is connected to the at least one third coolant outlet, the first, second, and third coolant channels disposed within an interior of the rotatable tool body.

16. A method of cooling a milling tool comprising:
rotating a tool body of a milling tool around an axis, a seating face of a cutting insert disposed against a seating surface of a pocket defined within a circumferential outer surface of the tool body, a rake face of the cutting insert opposed to the seating face; and
cooling the cutting insert disposed within the pocket by flowing coolant out of at least one first coolant outlet onto the cutting insert, the at least one first coolant outlet disposed on an opposite side of the rake face as the seating face and disposed in or attached to the tool body, and by flowing the coolant out of at least one second coolant outlet onto the cutting insert, the at least one second coolant outlet disposed on an opposite side of the seating face as the rake face outside of and adjacent to the seating face and disposed in or attached to the tool body.

17. The method of claim 16 further comprising cooling the cutting insert disposed within the pocket by flowing the coolant out of at least one third coolant outlet onto the cutting insert, the at least one third coolant outlet disposed in or attached to the tool body, the at least one third coolant outlet disposed on the opposite side of the rake face as the seating face.

18. The method of claim 17 further comprising cooling a first cutting edge of the cutting insert by discharging the coolant out of the second and third coolant outlets, and cooling a second cutting edge of the cutting insert by discharging the coolant out of the at least one first coolant outlet.

19. The method of claim 18 further comprising cooling 100% of lengths of the first and second cutting edges by discharging the coolant out of the first, second, and third coolant outlets.

20. The method of claim 17 further comprising providing the coolant to the at least one first coolant outlet through a first coolant channel disposed within an interior of the tool body, providing the coolant to the at least one second coolant outlet through a second coolant channel disposed within the interior of the tool body, and providing the coolant to the at least one third coolant outlet though a third coolant channel disposed within the interior of the tool body.
